(19) United States
(12) Patent Application Publication
(10) Pub. No.: US 2008/0130100 A1
(43) Pub. Date: Jun. 5, 2008

(54) High-efficiency, high-reliability fiber amplifier using engineered passband of photonic bandgap optical fiber

(75) Inventor: Cooper Dominic Babich, Park Ridge, IL (US)

Correspondence Address: STETINA BRUNDA GARRED & BRUCKER, 75 ENTERPRISE, SUITE 250, ALISO VIEJO, CA, 92656, US

(73) Assignee: Northrop Grumman Corporation

(21) Appl. No.: 11/606,540

(22) Filed: Nov. 30, 2006

(51) Int. Cl. H01S 3/09; H01S 3/00

(52) U.S. Cl. 359/341.3; 359/341.1

(57) ABSTRACT

A fiber amplifier is configured such that its spontaneous emissions are filtered out at the instant of creation. The fiber optic amplifier combines the gain medium of the fiber optical amplifier with a continuous filter to filter out the spontaneous emissions to prevent spontaneously emitted photons from stealing gain from signal photons. The photonic crystal fiber has a central core doped with a gain medium such as erbium, ytterbium or thulium ions. The central core of the photonic crystal fiber is surrounded by a cladding region having an array of holes or air voids that may be filled with materials with refractive index different from that of the central core. The array of holes are configured to restrict the wavelength range within which light can propagate inside the central core thereby providing continuous filtering functionality. The fiber amplifier has a pump operative to generate pump energy that is coupled to the photonic crystal fiber simultaneously with the signal. The wavelength of the pump energy is within the absorption band of the gain medium to facilitate amplification of the signal.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates in generally to an optical fiber amplifier, and more particularly, to a high-efficiency, high-reliability fiber amplifier using an engineered passband of photonic bandgap optical fiber.

A typical fiber amplifier configuration is disclosed in the document entitled “Erbium-Doped Fiber Amplifiers: Fundamentals and Technology” by P. C. Becker et al., the entire contents being incorporated by reference herein. In conventional optical fibers, total internal reflection is responsible for the guiding of light therein. Based on the principle of total internal reflection (TIR), an optical fiber typically consists of a central core surrounded by a cladding layer whose index of refraction n₂ is slightly lower than that n₁ of the core. The optical fiber is characterized by a normalized frequency as a function of the radius of the core and the core-cladding index difference which is itself a function of the wavelengths of the guided optical beam. The normalized frequency determines the number of modes supported by the fiber.

The dependence upon wavelength indicates that conventional fibers can maintain single-mode propagation area over a limited wavelength range. The wavelength range is typically between 10% and 50% of the central wavelengths. For example, if the central wavelength at which the fiber propagates in single mode is 3 micrometers, the range is typically between 0.3 and 1.5 micrometers, which indicates 2.85 to 3.15 micrometers on one extreme and 2.25 to 3.75 micrometers on the other. Beneath the low end of the wavelength range, propagation of multiple modes is supported. Above the high end of the wavelength range, no modes are supported without very high losses or very stringent restrictions on bending, vibration, and micro-discontinuities in the fiber.

Although widely used in a variety of applications including, but not limited to, illumination systems, sensors, and imaging systems, optical fibers have also been broadly applied to communication systems to exploit the vast bandwidth available in a reliable, cost-effective manner. In recent years, optical fiber amplifiers (OFA) incorporating doped fiber as the gain medium have received a tremendous level of interest. One of the most common forms of the optical fiber amplifier is doped with erbium and is referred to as an erbium-doped fiber amplifier (EDFA).

To provide a fiber amplifier that is suitable for use in most applications, many of the cores of the optical fiber amplifiers have been doped with erbium as the active ions and co-dopants such as aluminum and germanium serving to broaden the spectral envelope, increase the solubility of the erbium in silica, and modify the refractive index profile. A pump source excites the gain medium to facilitate amplification of the signal. During operation of the fiber amplifier, noise photons are spontaneously emitted across the entire gain spectrum and amplified by “stealing” excited gain-medium atoms that would otherwise amplify the signal, which usually has a much smaller spectral width.

Conventionally in systems that use EDFA's, a spectral filter is applied to reduce the amount of this amplified spontaneous emission (ASE) noise. The disadvantage of such approach is that a significant portion of EDFA pump energy that is typically generated by a pump laser is wasted in amplifying the noise instead of being applied to amplify the desired signal. Because the pump energy has been consumed in the amplified spontaneous emission of noise photons, higher pump power levels are required to obtain the desired amplification gain. Higher pump powers are more expensive to obtain and/or are less reliable to operate.

In consideration of the foregoing, there exists a substantial need in the art to provide a fiber amplifier which effectively suppresses the amplified spontaneous emission of noise without wasting pumping energy. One arrangement that meets this need is a configuration in which the spontaneous emission is filtered out as soon as it is created (i.e., before it is amplified).

### BRIEF SUMMARY

To mitigate the amplified spontaneous emission problem described above, a uniquely-configured photonic crystal fiber is applied in a fiber amplifier to allow only a narrow band of light energy centered at a specific wavelength to transmit through. A typical fiber amplifier configuration is also disclosed in the document entitled “Erbium-Doped Fiber Amplifiers: Fundamentals and Technology” by P. C. Becker et al. In the present invention, the amplified spontaneous emission is “continuously filtered” in a manner similar to that which is described in the document entitled “Distributed fiber filter based on index-matched coupling between core and cladding” by John M Fini et al. published Dec. 12, 2005 in Vol. 13, No. 25 edition of Optics Express, the entire contents being incorporated by reference herein.

In the present invention, the photonic crystal fiber includes a central core doped with a gain medium, including rare earth ions such as erbium, ytterbium or thulium ions. The central core of the photonic crystal fiber may be surrounded by a cladding region comprising an array of holes or voids filled with materials with refractive index different from that of the central core. The fiber amplifier includes a pump beam operative to generate pump energy that is coupled to the photonic crystal fiber simultaneously with the signal. The wavelength of the pump energy is within the absorption of the gain medium to facilitate amplification of the signal. For example, the wavelength of the pump energy is preferably 980 nm or 1480 nm if the gain medium is an erbium-doped fiber.

The amplifier further comprises a coupler operative to couple the pump energy and the signal to be amplified into the photonic crystal fiber, such that the signal can be amplified and output from an opposite end of the photonic crystal fiber. The coupler may include a free-space multiplexer or a fused fiber wavelength division multiplexer (WDM) or a thin film filter WDM or any other suitable WDM technology such as cladding pumping. By adjusting the quantity, shape, configuration, dimensions, locations and distance between the holes in the cladding region, the passband of the photonic crystal fiber can be reduced narrower than the gain spectrum.

Therefore, the amplified spontaneous emission outside the narrow passband will escape the fiber without being amplified such that the energy of the pump can be better utilized for amplifying the signal. The optical conversion efficiency of the amplifier is thus improved with a relatively low cost, small size, high power efficiency and reliability gains. The above-described concept can be applied to multiple passbands centered at different wavelengths, all within the gain spectrum.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic drawing of a photonic crystal fiber amplifier;

FIG. 2 shows the transition of energy-level in erbium;

FIG. 3 is a schematic representation of the amplification mechanism for a signal and spontaneous emission along a length of erbium fiber; and

FIG. 4 shows a cross-sectional view of an exemplary photonic crystal fiber used in a fiber amplifier system.

### DETAILED DESCRIPTION

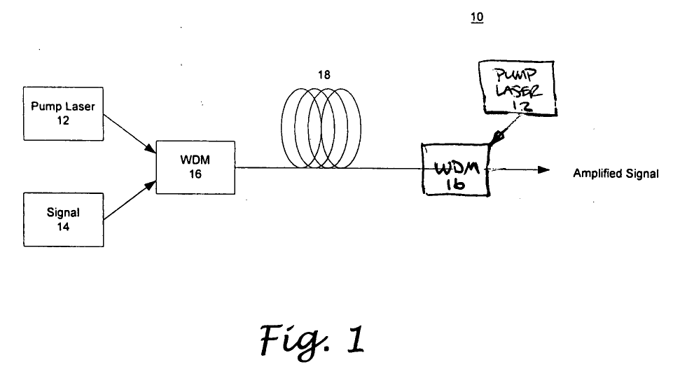

FIG. 1 provides a schematic illustration of a photonic crystal fiber amplifier 10. As shown, the photonic crystal fiber amplifier 10 includes at least one pump energy source 12, at least one coupler 16, and a length of optical fiber 18. Preferably, the pump energy source 12 includes a pump laser operative to generate a pump beam at a specific wavelength. A signal source 14 is adapted to generate a signal. The coupler 16 includes a wavelength division multiplexer or a conventional optical coupler operative to simultaneously couple the pump beam energy with the signal 14 for transmission from either end of the optical fiber 18. For example, FIG. 1 illustrates that the photonic crystal amplifier 10 can also be provided in a dual-pump 12 version. The photonic optical fiber 18 is doped with a gain medium such as erbium, ytterbium, thulium or other rare earth ions.

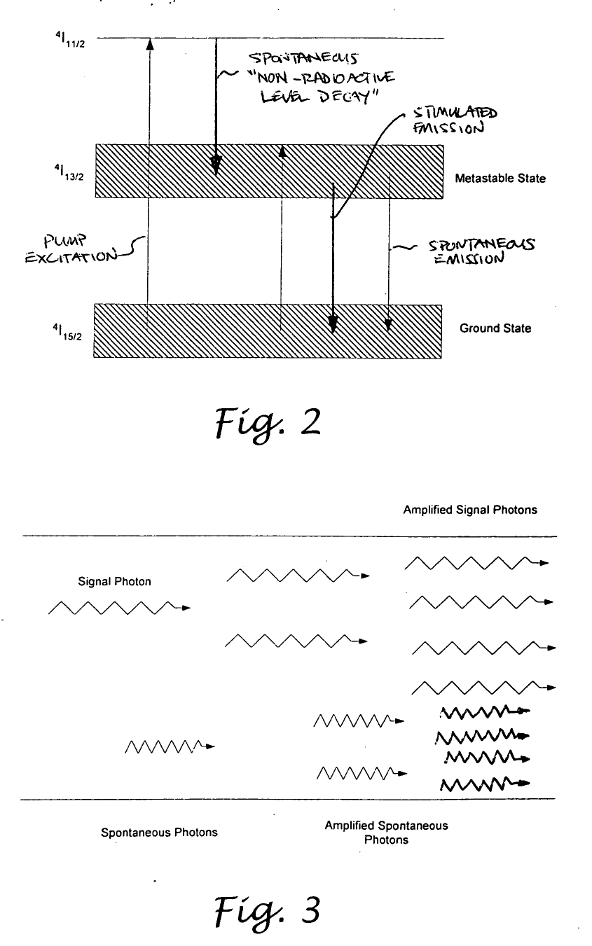

FIG. 2 illustrates the energy-level transition in erbium. As shown, there are three energy levels in the amplification process of erbium. When the pump laser beam and the signal 14 to be amplified are coupled into the optical fiber 18 simultaneously, the pump energy at 980 nm is absorbed by the fiber to stimulate erbium ions into the ⁴I_{11/12} states. As the excited state ⁴I_{11/12} has a lifetime as short as about 1 μs, there follows a non-radioactive level decay to the ⁴I_{13/2} state, known as the metastable state, having a spontaneous lifetime as long as on the order of about 10 ms.

At the metastable state ⁴I_{13/2}, the excited ions may decay naturally to the ground state ⁴I_{15/2} and generate a photon of random phase at a wavelength anywhere within the gain spectrum. Alternatively, a photon propagating along the fiber may stimulate a transition from ⁴I_{13/2} to the ground state ⁴I_{15/2} to result in an additional photon of the same wavelength and phase. As shown in FIG. 3, during the amplification process, both the signal and the spontaneous photon are amplified as they propagate along the fiber. The amplified spontaneous emission (ASE) noise as introduced above is not related to the signal (different phase, random) and is a constituent of noise power generated within the device. Furthermore, any erbium ions that exist in their ground state may either absorb a pump photon as intended or less desirably, absorb a signal photon or an amplified spontaneous emission photon.

In order to suppress the amplified spontaneous emissions while more efficiently utilizing the pump energy, in one embodiment, the optical fiber 18 is selected from the photonic crystal fiber which is engineered with a profile of refractive index that allows only a narrow band centered at the wavelength of the signal to be amplified to pass while preventing other bands of energy to transmit within the core within which the gain medium lies. The fiber amplifier couples into a radiative mode the spontaneous emission of photos upon there generation. The photonic crystal fiber is configured such that only a band no wider than the entire gain bandwidth centered at the wavelength of the signal to be amplified is allowed to pass.

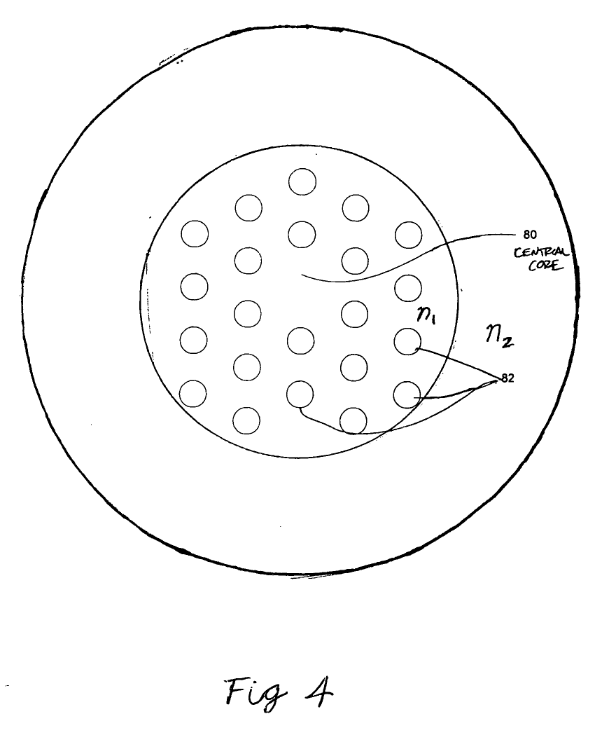

FIG. 4 illustrates the partial cross sectional view of an exemplary photonic crystal fiber 18. As shown, the photonic crystal fiber 18 includes a central solid core 80 surrounded by a plurality of holes 82 to serve as a cladding region of the central core 80. In one embodiment, the central core 80 may be fabricated from silica and the holes 82 may be filled with air. To facilitate amplification of an incoming signal, the central core 80 is doped with an active material, that is, a gain medium such as rare-earth ions, including erbium, ytterbium or thulium. Aluminum and germanium may be used as co-dopants for the gain medium.

As is known in the art, the quantity, shape, configuration, dimensions, and locations of the holes 82 and the distance between the holes 82 may be adjusted to achieve a refractive index profile that allows only a narrow spectral band of optical energy to pass through. The holes 82 are optimized according to the frequency of the signal to be amplified and the required width of the pass band. Preferably, the passband is no broader than 1 nm, such that the vast majority of amplified spontaneous emission noise (outside of the narrow passband) will escape the fiber without being amplified. Consequently, the pump energy can be efficiently applied to amplify the incoming signal. The holes 80 may also be vacuum or filled with gas or solid material. The photonic crystal fiber 18 may be configured with a double-cladding structure that includes two concentric arrays of holes 82 surrounding the central core 80, or another material n₂. The above-described concept can be applied to multiple passbands centered at different wavelengths, all within the gain spectrum.

The above description is given by way of example, and not limitation. Given the above disclosure, one skilled in the art could devise variations that are within the scope and spirit of the invention disclosed herein, including various ways of arranging the holes in the cladding region. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A fiber amplifier, comprising:
a pump source operative to generate pump energy at a first wavelength band;
a photonic crystal fiber doped with a gain medium having an absorption band overlapping the first wavelength range; and
at least one coupler operative to simultaneously couple the pump energy and a signal to be amplified to the photonic crystal fiber, the signal having a second wavelength band;
wherein the fiber amplifier couples into a radiative mode of the photonic crystal fiber the spontaneous emission of photons of wavelength other than the first or second wavelength bands upon generation thereof to prevent amplification of the photons such that the gain is instead provided to the signal photons.

2. The fiber amplifier of claim 1, wherein photonic crystal fiber being configured such that only a band no wider than the gain bandwidth centered at the second wavelength is allowed to pass.

3. The fiber amplifier of claim 1, wherein the pump energy source includes a pump laser source.

4. The fiber amplifier of claim 1, wherein the coupler includes a free space optical multiplexer.

5. The fiber amplifier of claim 1, wherein the coupler includes a fiber optic wavelength division multiplexer.

6. The fiber amplifier of claim 1, wherein the coupler includes cladding pumping.

7. The fiber amplifier of claim 1, wherein the photonic crystal fiber includes a central core doped with the gain medium and a plurality of holes surrounding the central core.

8. The fiber amplifier of claim 1, wherein the photonic crystal fiber is part of a dual-core fiber having an outer core containing the entire photonic crystal and being configured to propagate the pump wavelength therewithin.

9. The fiber amplifier of claim 1, wherein the gain medium includes erbium, ytterbium or thulium as active dopants and aluminum and germanium as co-dopants.

10. A fiber amplifier, comprising:
a doped optical fiber having a waveguide passband that is narrower that a gain spectrum of the dopant;
wherein spontaneous emission of the fiber optic amplifier is filtered out during generation thereof excluding the wavelength of the waveguide passband.

11. The fiber amplifier of claim 10, wherein the waveguide passband of the doped optical fiber is configured to be narrower than the gain spectrum by altering the index profile of the fiber.

12. The fiber amplifier of claim 10, further comprising:
a photonic crystal fiber including a central core having a plurality of holes surrounding the central core;
wherein the waveguide passband of the doped optical fiber is configured to be narrower than the gain spectrum optimizing the hole configuration.

13. A fiber amplifier, comprising:
a pump source operative to generate pump energy at a first wavelength band;
a photonic crystal fiber doped with a gain medium having an absorption band overlapping the first wavelength range; and
at least one coupler operative to simultaneously couple the pump energy and a signal to be amplified to the photonic crystal fiber, the signal having multiple wavelengths each having its own narrow passband within the gain spectrum;
wherein the fiber amplifier allows spontaneous emission of photons upon generation thereof to prevent amplification of the photons such that the gain is provided to the signal photons.

14. A photonic crystal fiber amplifier for amplifying a signal, comprising:
a photonic crystal fiber, comprising:
a core region doped with a gain medium having an absorption band; and
a cladding region comprising an array of holes filled with materials having a refractive index different from that of the core region; and
a pump beam source, operative to generate a pump beam at a wavelength within the absorption band; wherein:
the holes being sized, configured and arranged to eliminate amplified spontaneous emission noise at wavelengths different from a wavelength of the signal to be amplified.

15. The photonic crystal fiber of claim 14, further comprising a coupler operative to simultaneously couple the signal and the pump beam to the photonic crystal fiber.

16. The photonic crystal fiber of claim 14, wherein the gain medium includes at least one of erbium, ytterbium or thulium as active dopants and at least one of aluminum and germanium as co-dopants.

17. The photonic crystal fiber of claim 14, further comprising a coupler to simultaneously couple the signal and the pump energy to the photonic crystal fiber.

18. The photonic crystal fiber of claim 17, wherein the coupler comprises at least one of a free-space multiplexer and a fiber optic wavelength division multiplexer.

19. A photonic crystal fiber comprising a length of doped photonic crystal fiber, wherein the photonic crystal fiber is configured to narrow a passband thereof no broader than the gain spectrum.

20. The photonic crystal fiber of claim 19, wherein the passband is centered at a wavelength of a signal to be amplified by the photonic crystal fiber.

21. The photonic crystal fiber of claim 19, wherein the doped photonic crystal fiber includes an erbium, ytterbium or thulium doped photonic crystal fiber and at least one of aluminum and germanium as co-dopants.

22. The photonic crystal fiber of claim 19, wherein the doped photonic crystal fiber includes a central core doped with a gain medium and a cladding region comprising an array of holes of any shape surrounding the central core.

23. The photonic crystal fiber 22, wherein the holes are filled with materials having a refractive index different from that of the central core.

24. A photonic crystal fiber for amplifying an incoming signal at a wavelength, comprising a core doped with a gain medium and a cladding region, wherein the core and the cladding region are configured to eliminate amplified spontaneous emission at wavelengths different from the wavelength of the incoming signal.

25. The photonic crystal fiber of claim 24, wherein the cladding region includes at least an array of holes.
